(19) United States
(12) Patent Application Publication
(10) Pub. No.: US 2016/0062691 A1
(43) Pub. Date: Mar. 3, 2016

(54) METHOD FOR CONTROLLING MEMORY DEVICE TO ACHIEVE MORE POWER SAVING AND RELATED APPARATUS THEREOF

(71) Applicant: MEDIATEK INC., Hsin-Chu (TW)

(72) Inventors: Chin-Wen Chang, Taichung City (TW); Hsueh-Bing Yen, Hsinchu City (TW); Hung-Lin Chou, Hsinchu County (TW); Kuo-Hsien Lu, New Taipei City (TW); Kuang-Ting Chien, Hsinchu County (TW); Chih-Chieh Liu, Hsinchu City (TW); Nicholas Ching Hui Tang, Hsinchu County (TW)

(21) Appl. No.: 14/784,037

(22) PCT Filed: Mar. 13, 2015
(86) PCT No.: PCT/CN2015/074222

§ 371 Date: Oct. 13, 2015

Related U.S. Application Data
(60) Provisional application No. 61/952,549, filed on Mar. 13, 2014.

(51) Int. Cl. G06F 3/06; G06F 1/32

(52) U.S. Cl. CPC G06F 3/0625; G06F 1/3296; G06F 3/0644; G06F 3/0673

(57) ABSTRACT

A memory management method includes: performing a first-level collection operation upon first storage units in a memory pool allocated in a memory device; and after the first storage units are processed by the first-level collection operation, performing a second-level collection operation upon second storage units in the memory pool allocated in the memory device, wherein one of the first-level collection operation and the second-level collection operation is a page-level collection operation, and another of the first-level collection operation and the second-level collection operation is a bank-level collection operation.

### CROSS REFERENCE TO RELATED APPLICATIONS

This application claims the benefit of U.S. provisional application No. 61/952,549, filed on Mar. 13, 2014 and incorporated herein by reference.

### TECHNICAL FIELD

The present invention relates to controlling a memory device, and more particularly, to a method for controlling a memory device (e.g., a dynamic random access memory or any other memory device) to achieve more power saving and a related apparatus thereof.

### BACKGROUND

As a general development trend, processor speed, memory speed and memory capacity used in processing systems all increase with each new generation of the processing system. For example, the capacity/size of memory used in, for example, embedded systems has been continuously increasing in order to meet the performance needs. However, with this increase in memory capacity/size, an unwanted side effect is an increase in the memory power consumption. For example, the memory floor current may be the major contribution to the system power consumption. When the processing system is a mobile platform, the battery life of the mobile platform using the memory will be reduced.

To combat this problem, several low-power functions are developed. For example, the low-power functions for a Double Data Rate (DDR) memory may include a Full Array Self-Refresh function, a Partial Array Self-Refresh function, a Deep Power Down (DPD) function, and a Power Down function. Concerning the PASR function, it can save the power by disabling self-refresh of some memory segments (banks). Compared to the PASR function, the DPD function is an enhanced mechanism which gates most power supply to the DDR memory. Concerning the Power Down function, it is used to directly cut off the external power supply to at least a portion of the DDR memory.

When the processing system enters a suspend mode, the DDR memory can achieve lower power consumption through one of the aforementioned low-power functions. However, the power saving performance of the low-power function depends on distribution and number of free banks in the DDR memory. Thus, there is a need for an innovative design which can make an idle memory (e.g. dynamic random access memory (DRAM) or any other memory device) have more power saving.

### SUMMARY

One of the objectives of the claimed invention is to provide a method for controlling a memory device (e.g., a dynamic random access memory or any other memory device) to achieve more power saving and a related apparatus thereof.

According to a first aspect of the present invention, an exemplary memory management method is disclosed. The exemplary memory management method includes: utilizing a processor for performing a first-level collection operation upon first storage units in a memory pool allocated in a memory device; and after the first storage units are processed by the first-level collection operation, performing a second-level collection operation upon second storage units in the memory pool allocated in the memory device, wherein one of the first-level collection operation and the second-level collection operation is a page-level collection operation, and another of the first-level collection operation and the second-level collection operation is a bank-level collection operation.

According to a second aspect of the present invention, an exemplary power management method for a memory device is disclosed. The exemplary power management method includes: when a processor is in a sleep mode, utilizing a power management agent to monitor a memory access requirement of the memory device in real time; and controlling the memory device to switch from a first mode to a second mode according to a real-time monitoring result of the memory access requirement of the memory device, wherein a power consumption of the memory device in one of the first mode and the second mode is lower than a power consumption of the memory device in another of the first mode and the second mode.

According to a third aspect of the present invention, an exemplary computer readable medium storing a program code is disclosed. When executed by a processor, the program code instructs the processor to perform following steps: performing a first-level collection operation upon first storage units in a memory pool allocated in a memory device; and after the first storage units are processed by the first-level collection, performing a second-level collection operation upon second storage units in the memory pool allocated in the memory device, wherein one of the first-level collection operation and the second-level collection operation is a page-level collection operation, and another of the first-level collection operation and the second-level collection operation is a bank-level collection operation.

According to a fourth aspect of the present invention, an exemplary electronic device is disclosed. The exemplary electronic device includes a memory device and a power management agent. When a processor is in a sleep mode, the power management agent is configured to monitor a memory access requirement of the memory device in real time, and control the memory device to switch from a first mode to a second mode according to a real-time monitoring result of the memory access requirement of the memory device, wherein a power consumption of the memory device in one of the first mode and the second mode is lower than a power consumption of the memory device in another of the first mode and the second mode.

These and other objectives of the present invention will no doubt become obvious to those of ordinary skill in the art after reading the following detailed description of the preferred embodiment that is illustrated in the various figures and drawings.

### BRIEF DESCRIPTION OF DRAWINGS

FIG. 1 is a block diagram illustrating an electronic device according to an embodiment of the present invention.

FIG. 2 shows steps performed before the free bank collection is started.

FIG. 3 shows steps performed for doing the page-level collection operation.

FIG. 4 shows steps performed for doing the bank-level collection operation.

FIG. 5 is a diagram illustrating allocation of unevictable and/or unmovable pages according to an embodiment of the present invention.

FIG. 6 is a diagram illustrating an example of shrinking (dropping) a file-backed page (e.g., a file-backed user page).

FIG. 7 is a diagram illustrating an example of controlling migration of a file-backed page (e.g., a file-backed user page).

FIG. 8 is a diagram illustrating an example of applying compaction to a memory device to create one or more free banks.

FIG. 9 shows steps performed for doing the page-level collection operation with memory compression used therein.

FIG. 10 shows steps performed for doing the bank-level collection operation with compression indicators used therein.

FIG. 11 is a diagram illustrating an example of shrinking (dropping) a swap-backed page (e.g., a swap-backed user page) by using compression on a swap pool.

FIG. 12 is a diagram illustrating an example of shrinking (dropping) an unevictable and/or an unmovable page by using compression on a memory pool.

FIG. 13 is a flowchart illustrating a power management method of a memory device according to an embodiment of the present invention.

### DETAILED DESCRIPTION

Certain terms are used throughout the following description and claims, which refer to particular components. As one skilled in the art will appreciate, electronic equipment manufacturers may refer to a component by different names. This document does not intend to distinguish between components that differ in name but not in function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

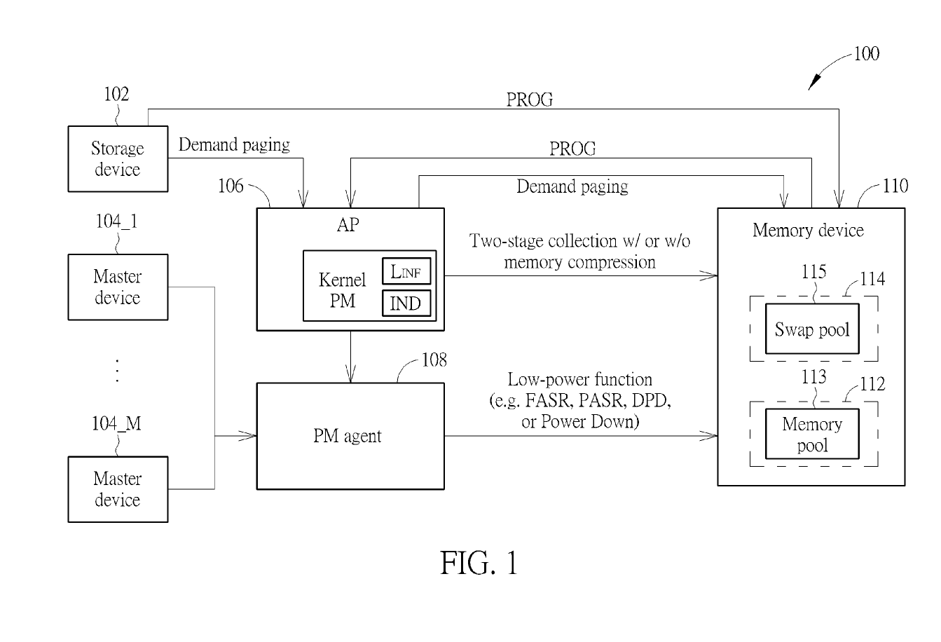

FIG. 1 is a block diagram illustrating an electronic device according to an embodiment of the present invention. The electronic device 100 may be at least a portion (i.e., part or all) of a mobile device, such as a mobile phone, a tablet, a wearable device, etc. In this embodiment, the electronic device 100 may include a storage device 102, one or more master devices 104_1-104_M, an application processor (AP) 106, a power management (PM) agent 108, and a memory device 110. The storage device 102 may be implemented using a non-volatile memory (e.g., a flash memory), a hard disk, etc. The memory device 110 may be a dynamic random access memory (DRAM), such as a low-power DDR (LPDDR) memory, or any other memory device. The memory device 110 may have a plurality of banks each having a plurality of pages (e.g., cache pages). In addition, the memory device 110 may be divided into a plurality of memory spaces, including at least a first memory space 112 and a second memory space 114 each having one or more banks, where the first memory space 112 may be configured to act as a memory pool 113, and the second memory space 114 may be configured to act as a swap pool 115. A program code PROG may be stored in the storage device 102. When the electronic device 100 is powered on, the program code PROG may be loaded into the memory device 110 for execution. For example, the program code PROG may be an operating system (OS) of the electronic device 100. Hence, the AP 106 may execute the program code PROG loaded from the memory device 110 to control operations of the electronic device 100. For example, the AP 106 may execute the program code PROG to run kernel power management for managing power consumption of the memory device 110 in a software-based manner. The master devices 104_1-104_M may be sub-systems in the electronic device 100, and may issue memory access requests (e.g., read requests and write requests) for accessing data in the memory device 110. In contrast to the kernel PM implemented by software running on the AP 106, the PM agent 108 may be implemented by hardware circuitry to thereby manage power consumption of the memory device 110 in a hardware-based manner. In this embodiment, the kernel PM running on the AP 106 may collaborate with the PM agent 108 to apply power management to the memory device 110 for achieving more power saving and/or longer battery life. Further details of the kernel PM running on the AP 106 and the auxiliary PM hardware realized using the PM agent 108 are described as below.

The AP 106 (more particularly, the kernel PM running on the AP 106) may perform a proposed two-stage collection procedure with/without memory compression to thereby collect free banks in the memory device 110. In this embodiment, the proposed two-stage collection procedure may include a first-level collection operation and a second-level collection operation. The first-level collection operation may be performed upon first storage units, such as pages (or banks), in the memory pool 113 allocated in the memory device 110. After the first storage units are processed by the first-level collection operation, the second-level collection operation may be performed upon second storage units, such as banks (or pages), in the memory pool 113 allocated in the memory device 110. One of the first-level collection operation and the second-level collection operation may be a page-level collection operation configured to be performed upon pages, and another of the first-level collection operation and the second-level collection operation may be a bank-level collection operation configured to be performed upon banks. In one exemplary design of the two-stage collection procedure, the bank-level collection operation may be performed before the page-level collection operation is started. In another exemplary design of the two-stage collection procedure, the bank-level collection operation may be performed after the page-level collection operation is accomplished. That is, the execution sequence of the page-level collection operation and the bank-level collection operation may be adjusted, depending upon actual design consideration.

In the following, it is assumed that the two-stage collection procedure performed by the AP 106 (more particularly, the kernel PM running on the AP 106) may include a page-level collection operation and a bank-level collection operation that are executed in order. However, this is for illustrative purposes only, and is not meant to be a limitation of the present invention. After reading paragraphs directed to the proposed two-stage collection procedure, a person skilled in the pertinent art should readily appreciate that reversing the execution sequence of the page-level collection operation and the bank-level collection operation is feasible. The same objective of achieving more power saving and/or longer battery life can be achieved. This also falls within the scope of the present invention.

For example, the kernel PM running on the AP 106 may be configured to perform the page-level collection operation upon pages in at least one bank of banks in the memory pool 113, and perform the bank-level collection operation upon the banks after the at least one bank is processed by the page-level collection, where the page-level collection operation may be performed upon the pages based at least partly on attributes of the pages.

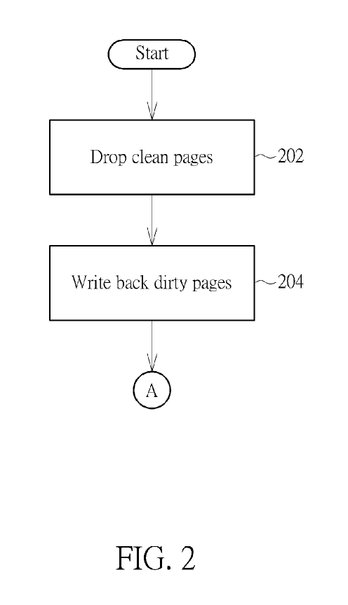

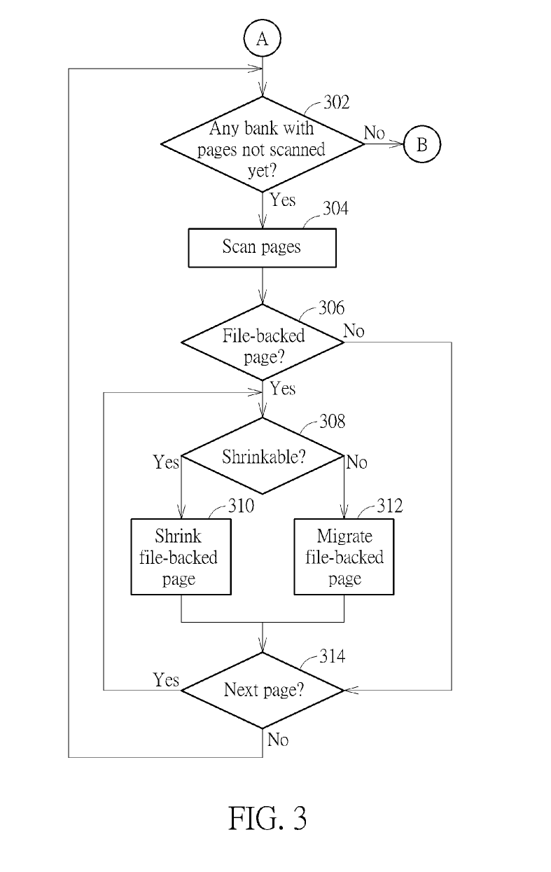

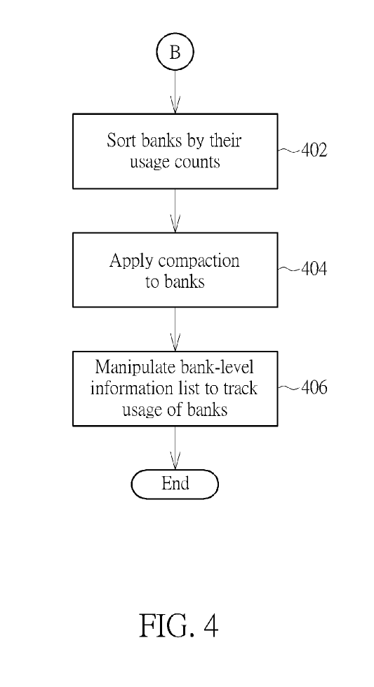

FIGS. 2-4 show a flowchart illustrating a memory management method for collecting free banks to shorten wakeup time and reduce power consumption according to an embodiment of the present invention. FIG. 2 shows steps performed before the free bank collection is started. FIG. 3 shows steps performed for doing the page-level collection operation. FIG. 4 shows steps performed for doing the bank-level collection operation. The steps are not required to be executed in the exact order shown in FIGS. 2-4. Besides, one or more steps shown in FIGS. 2-4 may be omitted, and one or more steps may be added.

The AP 106 may execute the program code PROG (e.g., OS of electronic device 100) to instruct allocation of unevictable and/or unmovable pages to use a specific memory range in the memory pool 113. For example, most pages used by the kernel directly cannot be moved, and unevictable pages are pages that can't be paged out (i.e., “evicted”) for a variety of reasons. As a person skilled in the art should readily understand definitions of unevictable page and unmovable page, further description is omitted here for brevity. When at least one of a Full Array Self-Refresh (FASR) function, a Partial Array Self-Refresh (PASR) function, a Deep Power Down (DPD) function and a Power Down function (which cuts off an external power supply) is performed upon at least a portion of the memory device 110, self-refresh may not be disabled in the specific memory range. Hence, page data in the specific memory range may not be lost when the memory device (e.g., LPDDR memory) 110 leaves a normal state and enters a self-refresh state due to the electronic device 100 entering a suspend mode.

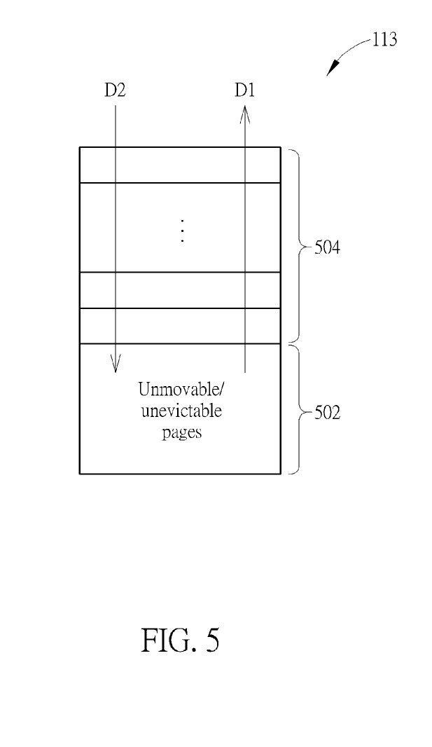

FIG. 5 is a diagram illustrating allocation of unevictable and/or unmovable pages according to an embodiment of the present invention. The memory pool 113 defined in the memory space 112 may be configured to have a specific memory range 502, where unevictable and/or unmovable pages may be allocated in the specific memory range 502. No matter which one of the FASR function, the PASR function, the DPD function and the Power Down function (which cuts off an external power supply) may be enabled, page data stored in the specific memory range 502 may be kept. Since a portion or all of the unevictable and/or unmovable pages may be allocated in the specific memory range 502, the following operation of gathering free banks can be easier and more efficient. Regarding the remaining memory range 504 in the memory pool 113, self-refresh may be disabled in at least a portion of the memory range 504 when at least one of the PASR function, the DPD function and the Power Down function (which cuts off an external power supply) is performed upon the memory range 504.

The kernel PM running on the AP 106 may drop/release clean page(s) in the memory device 110 to gather more free pages (step 202), where a “clean” page may mean that data of a page is identical to data of a corresponding file stored in the storage device 102. In addition, the kernel PM running on the AP 106 may write back dirty page(s) in the memory device 110 to file(s) in the storage device 102 for turning the dirty page(s) into clean page(s), and then may drop/release the clean page(s) to gather more free pages (step 204), where a “dirty” page may mean that data of a page is different from data of a corresponding file stored in the storage device 102.

When the page-level collection operation is started, the kernel PM running on the AP 106 may scan pages of each bank in the memory pool 113 allocated in the memory device 110. In step 302, the kernel PM running on the AP 106 may check if the memory device 110 has bank(s) with pages waiting for undergoing the page-level collection operation. When a bank is found having pages waiting for undergoing the page-level collection operation, the flow may proceed with step 304 to scan pages in the bank. Pages in each bank may be allocated in a page allocation direction. Hence, considering a case where the bank has free pages (i.e., pages not in use), the used pages will be located in the front portion of the bank (e.g., lower memory addresses in the bank) according to the page allocation direction, and the free pages will be located in the back portion of the bank (e.g., higher memory addresses in the bank) according to the page allocation direction. In this embodiment, the kernel PM running on the AP 106 may scan the pages in the bank according to a page scanning direction, where the page scanning direction may be opposite to the page allocation direction. Please refer to FIG. 5 again. The memory range 504 may have multiple banks, and pages in the memory range 504 may be allocated from lower memory addresses to higher memory addresses in the page allocation direction D1. The page scanning operation in step 304 may be performed based on the page scanning direction D2 shown in FIG. 5. When a page is a free page, the following steps of the page-level collection operation may be omitted. Thus, scanning pages in an inverse direction against page allocation can facilitate the page-level collection operation.

The kernel PM running on the AP 106 may check attributes of the pages to decide page types of the pages. In step 306, the kernel PM running on the AP 106 may check if an attribute of a specific page indicates that the specific page is a file-backed page (e.g., a file-backed user page that contains user data supported (“backed”) by a file in the storage device 102). If the specific page is not a file-backed page, the flow may proceed with step 314 to check if there are page(s) in the bank that wait for undergoing the page-level collection operation. However, if the specific page is a file-backed page, the flow may proceed with step 308.

A file-backed page may mean that the page is supported (“backed”) by a file in the storage device 102. Since data of the file-backed page in the memory device 110 is also kept in the storage device 102, shrinking (e.g., dropping) the file-backed page in the memory device 110 does not lose the data in the electronic device 100. Based on such observation, the present invention proposes shrinking (dropping) one or more file-backed pages in the memory device 110 to create one or more additional free pages in the memory device 110. In this embodiment, shrinking (dropping) file-backed pages may be controlled by a programmable page shrinking setting. For example, shrinking (dropping) file-backed pages with moderate configuration and intensity may be achieved based on the programmable page shrinking setting. Hence, it is possible that some of file-backed pages in a bank may be allowed to be shrunk (dropped), while some of file-backed pages in the same bank may not be allowed to be shrunk (dropped).

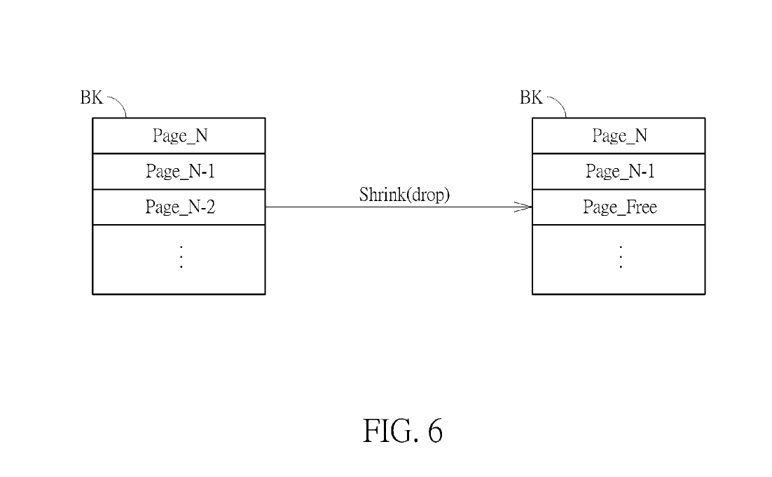

In step 308, the kernel PM running on the AP 106 may check if the file-backed page (e.g., file-backed user page) is allowed to be shrunk. If the file-backed page (e.g., file-backed user page) is allowed to be shrunk, the flow may proceed with step 310. In step 310, the kernel PM running on the AP 106 may shrink (drop) the file-backed page (e.g., file-backed user page). FIG. 6 is a diagram illustrating an example of shrinking (dropping) a file-backed page (e.g., a file-backed user page). In this example, one bank BK may have a plurality of pages, including Page_N, Page_N−1, Page_N−2, etc. Supposing that the page Page_N−2 may be a file-backed page (e.g., a file-backed user page) allowed to be shrunk, the kernel PM running on the AP 106 may shrink (drop) the file-backed page (e.g., file-backed user page) to turn the page Page_N−2 into a free page Page_Free.

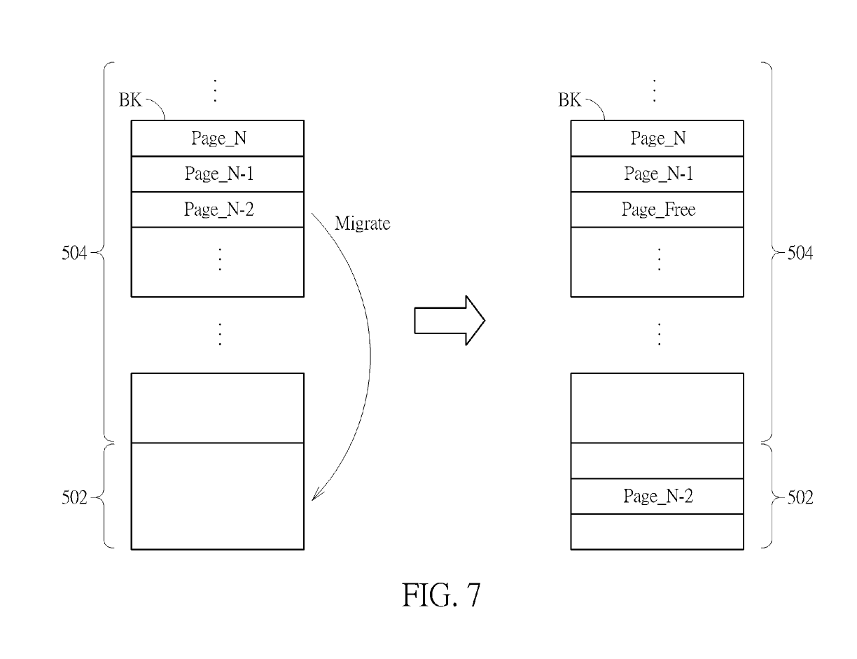

However, if the file-backed page (e.g., file-backed user page) is not allowed to be shrunk, the flow may proceed with step 312. In step 312, the kernel PM running on the AP 106 may control the file-backed page (e.g., file-backed user page) to migrate from the current memory address to the aforementioned specific memory range 502 allocated in the memory device 110. FIG. 7 is a diagram illustrating an example of controlling migration of a file-backed page (e.g., a file-backed user page). In this example, one bank BK may be part of the aforementioned memory range 504, and may have a plurality of pages, including Page_N, Page_N−1, Page_N−2, etc. Supposing that the page Page_N−2 may be a file-backed page (e.g., a file-backed user page) not allowed to be shrunk, the kernel PM running on the AP 106 may control the file-backed page (e.g., file-backed user page) to migrate from a current memory address to a free memory address in the memory range 502. As mentioned above, unevictable and/or unmovable pages may be allocated in the specific memory range 502, and self-refresh may not be disabled in the specific memory range 502 when at least one of an FASR function, a PASR function, a DPD function and a Power Down function (which cuts off an external power supply) is performed upon at least a portion of the memory device 110. Hence, the kernel PM running on the AP 106 may turn the page Page_N−2 into a free page Page_Free through applying page migration to the file-backed page (e.g., file-backed user page) not allowed to be shrunk.

When step 302 finds that there is no bank still having pages waiting for undergoing the page-level collection operation, the kernel PM running on the AP 106 may finish the page-level collection operation and then start the bank-level collection operation. In step 402, the kernel PM running on the AP 106 may sort banks in the memory pool 113 based on their usage counts. For example, the kernel PM running on the AP 106 may sort specific banks, each having movable pages only, in the memory pool 113 based on their usage counts. A usage count of a bank may be obtained by counting used pages in the bank. Therefore, the larger is the number of used pages, the usage count may be set by a larger value. Based on a sorting result of usage counts of banks, the kernel PM running on the AP 106 may distinguish between banks with larger usage counts and banks with smaller usage counts.

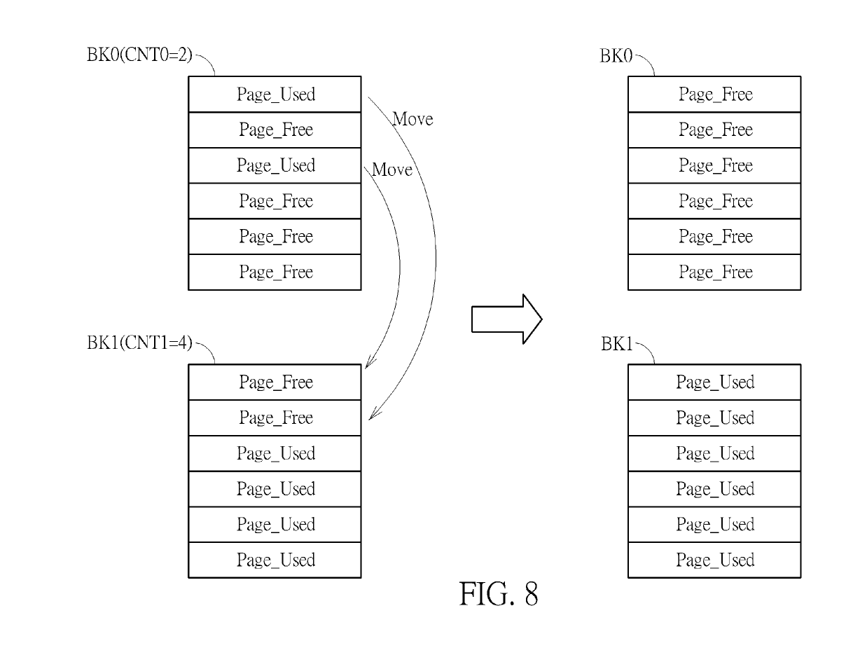

Next, the flow may proceed with step 404. In step 404, the kernel PM running on the AP 106 may apply compaction to at least a portion of the banks in the memory pool 113 to gather more free banks. For example, the kernel PM running on the AP 106 may move at least one page in use from a first bank with a first usage count to a second bank with a second usage count, where the second usage count may be larger than the first usage count. Hence, the number of used pages in the first bank can be reduced by the memory compaction operation. In other words, the memory compaction operation may make the memory pool 113 have more free banks due to the fact that all used pages in one bank with a smaller usage count may be moved to one or more banks with larger usage counts. FIG. 8 is a diagram illustrating an example of applying compaction to a memory device to create one or more free banks. In this example, each of the banks BK0 and BK1 may have six pages, where the bank BK0 may have two used pages Page_Used and four free pages Page_Free, and the bank BK1 may have four used pages Page_Used and two free pages Page_Free. Hence, the usage count CNT0 of the bank BK0 may be set by 2, and the usage count CNT1 of the bank BK1 may be set by 4. Since the usage count CNT0 of the bank BK0 is smaller than the usage count CNT1 of the bank BK1, the memory compaction operation may move at least one used page from the bank BK0 to the bank BK1. In this example, all of the used pages Page_Used in bank BK0 are moved to bank BK1. As shown in FIG. 8, free pages Page_Free in bank BK1 will be replaced by used pages Page_Used in bank BK0. Hence, after the memory compaction operation is done, the bank BK0 will become a free bank having free pages Page_Free only.

In step 406, the kernel PM running on the AP 106 may manipulate (e.g., construct or update) a bank-level information list LINF to track usage of banks in the memory pool 113. For example, the bank-level information list LINF may record memory locations of free banks in the memory pool 113. In this embodiment, free banks may not be released or returned to the system kernel unless more page allocations are required. Hence, the bank-level information list LINF generated in the bank-level collection operation of a current two-stage collection procedure may facilitate the bank-level collection operation of a next two-stage collection procedure. For example, when the bank-level information list LINF indicates that one bank is a free bank, there is no need to perform page-level collection operation and bank-level collection operation upon the free bank. In this way, unnecessary page-level operation(s) and bank-level operation(s) of the free bank can be avoided, thus leading to enhanced performance.

After the memory management method with the proposed two-stage collection procedure used for collecting free banks is completed, the AP 106 may enter a sleep mode, and the memory device 110 may be controlled to enter a low-power mode (e.g. self-refresh state). In this embodiment, the memory device 110 may support a low-power function under the low-power mode. For example, the memory device 110 may enter the low-power mode through enabling at least one of an FASR (full array self-refresh) function, a PASR function, a DPD function and a Power Down function (which cuts off an external power supply), where the power consumption of the memory device 110 in the low-power mode (e.g. self-refresh state) may be lower than the power consumption of the memory device 110 in the normal mode (e.g. normal memory read/write state). Further, when the memory device 110 leaves the low-power mode, the page(s) shrunk or moved by the memory management method may be restored to resume the normal mode of the memory device 110 as well as the AP 106. In this embodiment, a quick wakeup procedure may be employed. When a shrunk (dropped) file-backed page (e.g., file-backed user page) is referenced again, a page fault occurs. Hence, the shrunk (dropped) file-backed page (e.g., file-backed user page) can be loaded into the memory pool 113 by demand paging. In other words, no shrunk (dropped) file-backed page (e.g., file-backed user page) is required to be immediately loaded during a wakeup procedure.

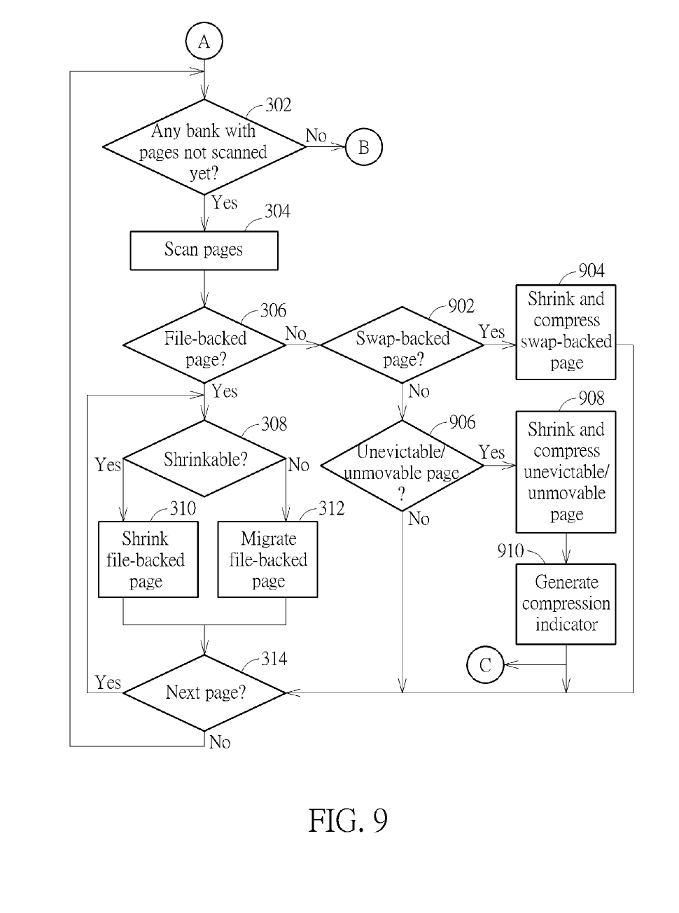

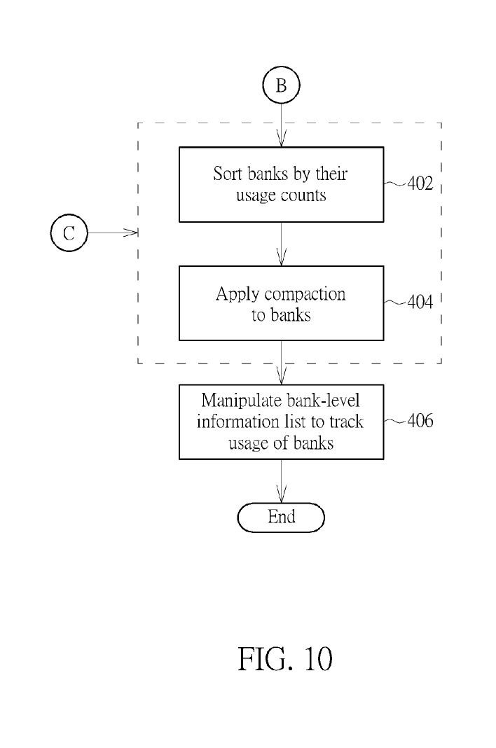

Concerning the memory management method shown in FIGS. 2-4, additional steps may be added to enhance the free bank collection performance. For example, memory compression may be involved in the page-level collection operation. Using memory compression may increase the possibility of successive free banks collected in the bank-level collection operation. FIGS. 2, 9, and 10 show a flowchart illustrating a memory management method for collecting free banks with memory compression according to an embodiment of the present invention. FIG. 9 shows steps performed for doing the page-level collection operation with memory compression used therein. FIG. 10 shows steps performed for doing the bank-level collection operation with compression indicators used therein. The steps are not required to be executed in the exact order shown in FIGS. 2, 9, and 10. Besides, one or more steps shown in FIGS. 2, 9 and 10 may be omitted, and one or more steps may be added.

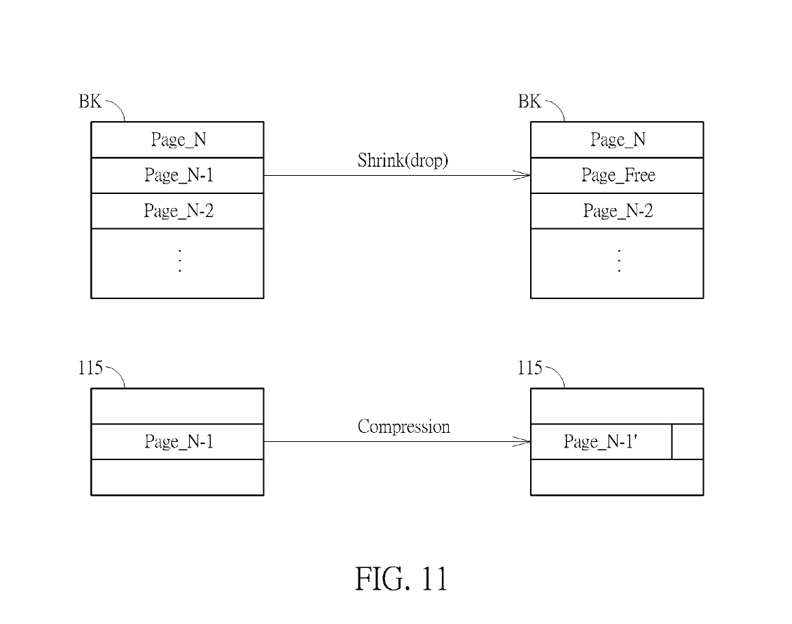

As mentioned above, step 306 may check if an attribute of a specific page indicates that the specific page is a file-backed page (e.g., a file-backed user page that contains user data supported (“backed”) by a file in the storage device 102). In this embodiment, when step 306 finds that the specific page is not a file-backed page, the flow may proceed with step 902. In step 902, the kernel PM running on the AP 106 may check if the attribute of the specific page indicates that the specific page is a swap-backed page (e.g., a swap-backed user page that contains user data supported (“backed”) by the swap pool 115 rather than the storage device 102). If the specific page is a swap-backed page, the flow may proceed with step 904 and then step 314. In step 904, the kernel PM running on the AP 106 may shrink (drop) the specific page by using compression on the swap pool 115. That is, the kernel PM running on the AP 106 may shrink (drop) the swap-backed page in the memory pool 113 allocated in the memory device 110, and compress a corresponding page stored in the swap pool 115 allocated in the memory device 110. FIG. 11 is a diagram illustrating an example of shrinking (dropping) a swap-backed page (e.g., a swap-backed user page) by using compression on a swap pool. In this example, one bank BK in the memory pool 113 may have a plurality of pages, including Page_N, Page_N−1, Page_N−2, etc. Supposing that the page Page_N−1 may be a swap-backed page (e.g., a swap-backed user page), the kernel PM running on the AP 106 may shrink (drop) the swap-backed page (e.g., swap-backed user page) to turn the page Page_N−1 in the memory pool 113 into a free page Page_Free, and may further apply compression to a corresponding page Page_N−1 supported (“backed”) in the swap pool 115 to have a compressed page Page_N−1′ stored in the swap pool 115.

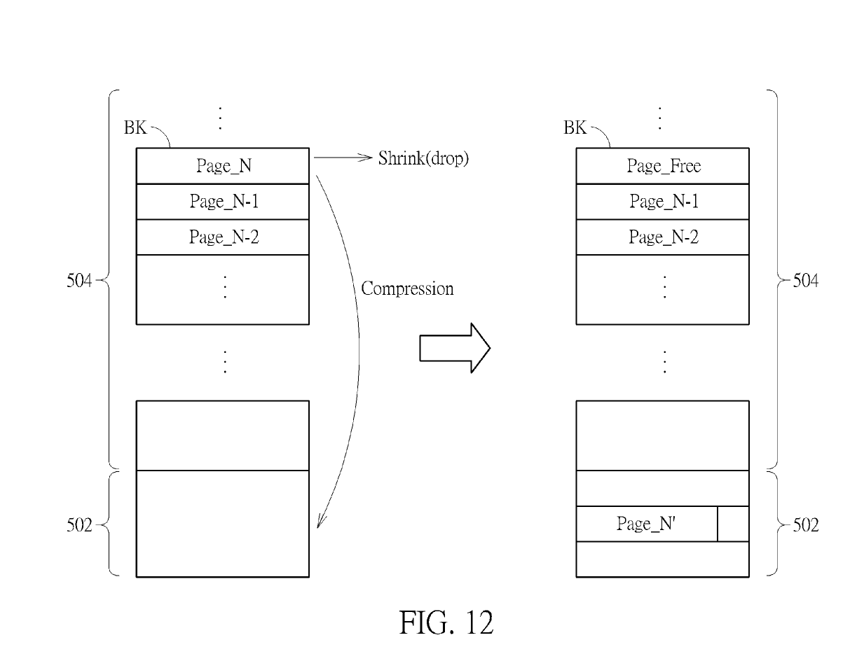

If step 902 finds that the specific page is not a swap-backed page, the flow may proceed with step 906. In step 906, the kernel PM running on the AP 106 may check if the attribute of the specific page indicates that the specific page is an unevictable/unmovable page. As mentioned above, a portion or all of the unevictable and/or unmovable pages may be controlled to be allocated in the specific memory range 502 shown in FIG. 5. However, it is possible that one or more unevictable and/or unmovable pages may be allocated in the memory range 504 of the memory pool 113 for certain reasons. In a case where an unevictable and/or an unmovable page is found in a bank belonging to the memory range 504, the flow may proceed with step 908. In step 908, the kernel PM running on the AP 106 may compress the specific page to generate a compressed page, store the compressed page in the specific memory range 502, and shrink (drop) the specific page. FIG. 12 is a diagram illustrating an example of shrinking (dropping) an unevictable and/or an unmovable page by using compression on a memory pool. In this example, one bank BK may have a plurality of pages, including Page_N, Page_N−1, Page_N−2, etc. Supposing that the page Page_N may be an unevictable and/or an unmovable page, the kernel PM running on the AP 106 may compress the page Page_N to generate a compressed page Page_N′ and store the compressed page Page_N′ into a free memory address of the specific memory range 502. As mentioned above, uncompressed unevictable and/or unmovable pages may be allocated in the specific memory range 502, and self-refresh may not be disabled in the specific memory range 502 when at least one of an FASR function, a PASR function, a DPD function and a Power Down function (which cuts off an external power supply) is performed upon at least a portion of the memory device 110. In addition, the kernel PM running on the AP 106 may shrink (drop) the page Page_N to turn the page Page_N into a free page Page_Free.

Next, the flow may proceed with step 910 and then step 314. In step 910, the kernel PM running on the AP 106 may generate a compression indicator IND for each specific page identified in step 906, where the compression indicator IND may include compression-related information (e.g., a compression source address, a compression destination address, etc.), and may be referenced by the bank-level collection operation as shown in FIG. 10. The unevictable and/or unmovable page may be needed by the system kernel at an unpredictable time. Hence, it is possible that the specific page (which is an unevictable and/or an unmovable page) may be needed by the system kernel after the compressed page is generated from compressing the specific page and stored into the specific memory range 502. In this case, the compressed page may be decompressed and restored to the memory range 504. Since the specific page is an unevictable and/or an unmovable page, the specific page should not be moved in the bank-level collection procedure. The compression indicator IND of the specific page therefore can be referenced by the bank-level collection procedure to avoid unnecessary page movement.

Concerning the memory management method for collecting free banks with memory compression as shown in FIGS. 2, 9, and 10, the page-level collection operation employs two technical features, including page shrinking and migration (steps 308-312) and memory compression (steps 902-910). However, this is for illustrative purposes only, and is not meant to be a limitation of the present invention. For example, any two-stage collection procedure using one or both of proposed page shrinking and migration (steps 308-312) and proposed memory compression (steps 902-910) falls within the scope of the present invention.

By way of example, but not limitation, the memory management method for collecting free banks (e.g., the exemplary flow shown in FIGS. 2-4 or FIGS. 2, 9 and 10) may be performed when the operating system of the electronic device 100 decides to enter a suspend mode. Hence, after the memory management method for collecting free banks is completed, the AP 106 may enter a sleep mode, and the memory device 110 may be controlled to enter a low-power mode (e.g. self-refresh state), where the memory device 110 may enter the low-power mode through enabling at least one of an FASR function, a PASR function, a DPD function and a Power Down function (which cuts off an external power supply). When operating in a normal mode, the AP 106 may fetch instructions and data from the memory device 110, and execute the fetched instructions to process the fetched data. The AP 106 may be configured to enter the sleep mode before the memory device 110 enters the low-power mode. If the AP 106 is used to manage low-power mode entry and low-power mode exit of the memory device 110, the AP 106 may need to run program codes on a non-turned-off memory such as internal statistic random access memory (SRAM), which increases the hardware cost inevitably. In this embodiment, an auxiliary hardware module (e.g., PM agent 108) may be used to manage low-power mode entry and low-power mode exit of the memory device 110. In this way, no additional non-turned-off memory may be needed by the AP 106, thus saving the hardware cost. Further, it is easy for the PM agent 108 to monitor memory access requests issued from the master devices 104_1-104_M and do suitable operations in response to a real-time monitoring result of a memory access requirement of the memory device 110. Further details of power management of the memory device 110 are described as below.

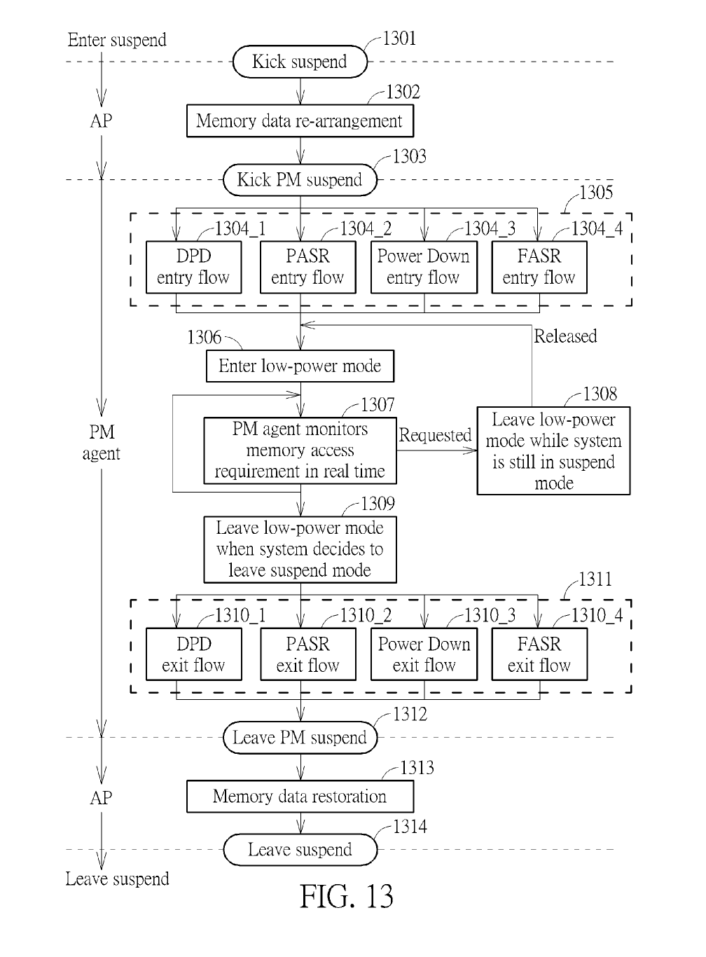

FIG. 13 is a flowchart illustrating a power management method of a memory device according to an embodiment of the present invention. The steps are not required to be executed in the exact order shown in FIG. 13. Besides, one or more steps shown in FIG. 13 may be omitted, and one or more steps may be added. When the operating system of the electronic device 100 decides to enter the suspend mode (step 1301), the kernel PM running on the AP 106 may perform a memory data re-arrangement task (e.g., the exemplary flow shown in FIGS. 2-4 or FIGS. 2, 9 and 10) to collect free banks (step 1302), and then hand over the control of the memory device 110 to the auxiliary hardware module (e.g., PM agent 108) for entering a sleep mode (step 1303). For example, the AP 106 may instruct the PM agent 108 to start monitoring a memory access requirement of the memory device 110 in real time, and then enter a sleep mode such as a Wait For Interrupt (WFI) mode.

When the AP 106 is in the sleep mode, the PM agent 108 may monitor the memory access requirement of the memory device 110 by detecting a memory access request issued from any of the master devices 104_1-104_M in a real-time manner, and may further control the memory device 110 to switch from a first mode to a second mode according to a real-time monitoring result of the memory access requirement of the memory device 110, where the power consumption of the memory device 110 in one of the first mode and the second mode may be lower than the power consumption of the memory device 110 in another of the first mode and the second mode. In this embodiment, the first mode may be a low-power mode (e.g., self-refresh state), and the second mode may be a normal mode (e.g., normal memory read/write state). It should be noted that controlling the memory device 110 to switch between the first mode and the second mode is for illustrative purposes only, and is not meant to be a limitation of the present invention. For example, the memory device 110 may be configured to support mode switching of more than two different operation modes.

In this embodiment, when the real-time monitoring result indicates that the memory access requirement of the memory device 110 does not exist, the PM agent 108 may control the memory device 110 to switch from the second mode (e.g., normal mode) to the first mode (e.g., low-power mode) by enabling at least one of an FASR function, a PASR function, a DPD function and a Power Down function (which cuts off an external power supply), such that at least a portion of the memory device 110 may be in at least one of an FASR state, a PASR state, a DPD state and an external power supply cut-off state under the first mode (step 1305). Based on distribution and number of free banks collected in step 1302, the PM agent 108 may decide whether one or more of FASR function, PASR function, DPD function and Power Down function (which cuts off an external power supply) should be enabled for saving power. If the DPD function is selected, the PM agent 108 may start a DPD entry flow to make certain memory rank(s)/die(s) enter the DPD state (step 1304_1). If the PASR function is selected, the PM agent 108 may start a PASR entry flow to program one or more mode registers (e.g., MR16 and/or MR17) in order to enable the PASR function on one or more segments/banks of the memory device 110 (step 1304_2). If the Power Down function is selected, the PM agent 108 may start a Power Down entry flow to cut off the external power supply to certain memory rank(s)/die(s) (step 1304_3). If the FASR function is selected, the PM agent 108 may start an FASR entry flow to enable the FASR function on all segments/banks of the memory device 110 (step 1304_4). As a result, the memory device 110 enters a low-power mode with a low-power function enabled (step 1306).

It should be noted that, after the memory device 110 is in the low-power mode, the PM agent 108 may keep monitoring the memory access requirement of the memory device 110, for example, by detecting a memory access request issued from any of the master devices 104_1-104_M in a real-time manner (step 1307). When the real-time monitoring result indicates that the memory access requirement of the memory device 110 exists (e.g., a specific master device may issue a memory access request), the PM agent 108 may control the memory device 110 to switch from the first mode (e.g., low-power mode) to the second mode (e.g., normal mode) for leaving the low-power mode to serve the memory access request, and may further notify the specific master device that the memory device 110 is available now (step 1308). It should be noted that the setting of the low-power function may be kept intact. Hence, when the memory device 110 enters the low-power mode again, the low-power function will be resumed.

After the specific master device finishes accessing the memory device 110, the memory access request may be released by the specific master device. At this moment, the real-time monitoring result may indicate that the memory access requirement of the memory device 110 does not exist, the PM agent 108 may control the memory device 110 to switch from the second mode (e.g., normal mode) to the first mode (e.g., low-power mode) to re-enter the low-power mode (step 1306).

Further, when an event triggers the operating system to leave the suspend mode, the PM agent 108 may start controlling the memory device 110 to leave the low-power mode through switching the memory device 110 from the first mode (e.g., low-power mode) to the second mode (e.g., normal mode) (steps 1309 and 1311). In a case where the DPD function is enabled in step 1305, the PM agent 108 may start a DPD exit flow to perform memory reset initialization for making certain memory ranks/dies leave the DPD state (step 1310_1). In another case where the PASR function is enabled in step 1305, the PM agent 108 may start a PASR exit flow to program one or more mode registers (e.g., MR16 and/or MR17) in order to disable the PASR function on certain segment(s)/bank(s) of the memory device 110 (step 1310_2). In yet another case where the Power Down function is enabled in step 1305, the PM agent 108 may start a Power Down exit flow to perform memory reset initialization and allow the external power supply to certain memory ranks/dies (step 1310_3). In further another case where the FASR function is enabled in step 1305, the PM agent 108 may start an FASR exit flow to disable the FASR function on all segments/banks of the memory device 110 (step 1310_4). Next, the AP 106 may be woken up from sleep-mode by, for example, the PM agent 108. The PM agent 108 may hand over the control of the memory device 110 to the normal-mode AP 106, and stop monitoring the memory access requirement of the memory device 110 in real time (step 1312).

In step 1313, the AP 106 may perform a memory data restoration task corresponding to the memory data re-arrangement task performed in step 1302. For example, the compressed page may be decompressed and restored. In the end, the operating system of the electronic device 100 may leave the suspend mode and enter the normal mode (step 1314).

Those skilled in the art will readily observe that numerous modifications and alterations of the device and method may be made while retaining the teachings of the invention. Accordingly, the above disclosure should be construed as limited only by the metes and bounds of the appended claims.

1. A memory management method comprising:
utilizing a processor for performing a first-level collection operation upon first storage units in a memory pool allocated in a memory device; and
after the first storage units are processed by the first-level collection operation, performing a second-level collection operation upon second storage units in the memory pool allocated in the memory device;
wherein one of the first-level collection operation and the second-level collection operation is a page-level collection operation, and another of the first-level collection operation and the second-level collection operation is a bank-level collection operation.

2. The memory management method of claim 1, wherein pages in at least one bank of banks in the memory pool are allocated in a page allocation direction, and performing the page-level collection operation comprises:
scanning the pages according to a page scanning direction, wherein the page scanning direction is opposite to the page allocation direction.

3. The memory management method of claim 1, wherein there are pages in at least one bank of banks in the memory pool, and performing the page-level collection operation comprises:
performing the page-level collection operation upon the pages based at least partly on attributes of the pages.

4. The memory management method of claim 3, wherein performing the page-level collection operation upon the pages based at least partly on the attributes of the pages comprises:
when an attribute of a specific page indicates that the specific page is a file-backed page and the specific page is allowed to be shrunk, shrinking the specific page.

5. The memory management method of claim 4, wherein after the specific page is shrunk, the specific page is loaded into the memory pool by demand paging.

6. The memory management method of claim 3, wherein performing the page-level collection operation upon the pages based at least partly on the attributes of the pages comprises:
when an attribute of a specific page indicates that the specific page is a file-backed page and the specific page is not allowed to be shrunk, controlling the specific page to migrate to a specific memory range in the memory pool.

7. The memory management method of claim 6, wherein when at least one of a Full Array Self-Refresh (FASR) function, a Partial Array Self-Refresh (PASR) function, a Deep Power Down (DPD) function and a function of cutting off an external power supply is performed upon at least a portion of the memory device, self-refresh is not disabled in the specific memory range.

8. The memory management method of claim 6, wherein unevictable pages and/or unmovable pages are allocated in the specific memory range.

9. The memory management method of claim 3, wherein performing the page-level collection operation upon the pages based at least partly on the attributes of the pages comprises:
when an attribute of a specific page indicates that the specific page is a swap-backed page, shrinking the specific page in the memory pool and compressing a corresponding page stored in a swap pool allocated in the memory device.

10. The memory management method of claim 3, wherein performing the page-level collection operation upon the pages based at least partly on the attributes of the pages comprises:
when an attribute of a specific page indicates that the specific page is an unevictable page or an unmovable page, compressing the specific page to generate a compressed page, storing the compressed page in a specific memory range in the memory pool, and shrinking the specific page.

11. The memory management method of claim 10, wherein when at least one of a Full Array Self-Refresh (FASR) function, a Partial Array Self-Refresh (PASR) function, a Deep Power Down (DPD) function and a function of cutting off an external power supply is performed upon at least a portion of the memory device, self-refresh is not disabled in the specific memory range.

12. The memory management method of claim 10, wherein performing the page-level collection operation upon the pages based at least partly on the attributes of the pages further comprises:
generating a compression indicator for the specific page, wherein the compression indicator includes compression-related information of the specific page, and is referenced by the bank-level collection operation.

13. The memory management method of claim 1, wherein there are banks in the memory pool, and performing the bank-level collection operation comprises:
applying compaction to at least a portion of the banks, comprising:
moving at least one page in use from a first bank with a first usage count to a second bank with a second usage count, wherein the second usage count is larger than the first usage count.

14. The memory management method of claim 13, wherein performing the bank-level collection operation further comprises:
manipulating a bank-level information list to track usage of the banks.

15. A power management method for a memory device comprising:
when a processor is in a sleep mode:
utilizing a power management agent to monitor a memory access requirement of the memory device in real time; and
controlling the memory device to switch from a first mode to a second mode according to a real-time monitoring result of the memory access requirement of the memory device;
wherein a power consumption of the memory device in one of the first mode and the second mode is lower than a power consumption of the memory device in another of the first mode and the second mode.

16. The power management method of claim 15, further comprising:
utilizing the processor to instruct the power management agent to start monitoring the memory access requirement of the memory device in real time; and
configuring the processor to enter the sleep mode.

17. The power management method of claim 15, further comprising:
utilizing the power management agent to wake up the processor; and
configuring the power management agent to stop monitoring the memory access requirement of the memory device in real time.

18. The power management method of claim 15, further comprising:
when the real-time monitoring result indicates that the memory access requirement of the memory device does not exist, controlling the memory device to switch from the second mode to the first mode, wherein at least a portion of the memory device is in at least one of a Full Array Self-Refresh (FASR) state, a Partial Array Self-Refresh (PASR) state, a Deep Power Down (DPD) state and an external power supply cut-off state under the first mode.

19. The power management method of claim 15, wherein controlling the memory device to switch from the first mode to the second mode comprises:
when the real-time monitoring result indicates that the memory access requirement of the memory device exists, controlling the memory device to switch from the first mode to the second mode, wherein at least one of a Full Array Self-Refresh (FASR) state, a Partial Array Self-Refresh (PASR) function, a Deep Power Down (DPD) function and a function of cutting off an external power supply is performed upon at least a portion of the memory device under the first mode.

20. A computer readable medium storing a program code, wherein when executed by a processor, the program code instructs the processor to perform following steps:
performing a first-level collection operation upon first storage units in a memory pool allocated in a memory device; and
after the first storage units are processed by the first-level collection operation, performing a second-level collection operation upon second storage units in the memory pool allocated in the memory device;
wherein one of the first-level collection operation and the second-level collection operation is a page-level collection operation, and another of the first-level collection operation and the second-level collection operation is a bank-level collection operation.

21. An electronic device comprising:
a memory device; and
a power management agent, wherein when a processor is in a sleep mode, the power management agent is configured to monitor a memory access requirement of the memory device in real time, and control the memory device to switch from a first mode to a second mode according to a real-time monitoring result of the memory access requirement of the memory device;
wherein a power consumption of the memory device in one of the first mode and the second mode is lower than a power consumption of the memory device in another of the first mode and the second mode.
